(19) United States
(12) Patent Application Publication
(10) Pub. No.: US 2012/0121351 A1
(43) Pub. Date: May 17, 2012

(54) DEEP HOLE DRILL

(75) Inventor: Juergen Deeg, Metzingen (DE)

(73) Assignee: BOTEK PRAEZISIONSBOHRTECHNIK GMBH, Riederich (DE)

(21) Appl. No.: 13/381,196

(22) PCT Filed: Jun. 25, 2010
(86) PCT No.: PCT/DE2010/000733

§ 371 Date: Jan. 23, 2012

(30) Foreign Application Priority Data
Jun. 29, 2009 (DE) 10 2009 031 193.9
Sep. 16, 2009 (DE) 20 2009 012 568.8

(51) Int. Cl. B23B 51/00; B23B 41/02

(52) U.S. Cl. 408/200; 408/199; 408/224

(57) ABSTRACT

The invention relates to a deep hole drill comprising at least one cutter (S), which is formed on a drill head and which has at least one cutting edge, the at least one cutter being divided into at least two sub-cutters (T1, T2) by at least one chip divider (ST) for dividing the chips removed by the cutting edge, the deep hole drill being characterized in that the sub-cutters (T1, T2) of at least one cutter are arranged relative to each other in such a way that the cutter normals (N1, N2) of at least two sub-cutters (T1, T2) are aligned at an angle of at least 20° to each other.

### DESCRIPTION OF THE PRIOR ART

The invention relates to a deep hole drill of the kind according to the independent claim 1.

Deep hole drills are used for introducing boreholes into workpieces. Different kinds of deep hole drills are represented in the VDI guideline VDI 3210. Deep hole drills are mainly used for producing boreholes with comparatively small diameters which predominantly lie in the range of 0.5 m to 50 mm, wherein the drilling depth can be a multiple of the drilling diameter. Conventional values for the drilling depth lie in the range of 20 times to 100 times of the drilling diameter, but can also be above or below this figure.

Deep hole drills are usually accommodated on the machine side at their clamping end in a receiver provided for this purpose in a spindle and are made to rotate by the spindle around the central axis of the drill. At the same time, the tool is moved along its central axis with a defined feed towards the workpiece per rotation. The deep hole drill penetrates the workpiece in this process and the material of the workpiece is cut on its cutters and severed from the workpiece in form of chips. The chips produced thereby are cooled by means of a coolant which is supplied through interior channels via the spindle and flushed out of the borehole along chip removal grooves.

It is also possible to have the workpiece perform the rotation and/or the feeding movement or to have the rotation and/or the feeding movement be performed partly by the tool and partly by the workpiece.

Generally, deep hole drills consist of a drill head and a drill shank with a clamping end. At least one cutter is formed on the drill head, which cutter extends from the central axis of the drill up to the circumference of the drill. Furthermore, guide elements can be provided which are arranged on the circumference of the drill head. The drill head and the drill shank are either connected with one another in an interlocking fashion or they are made integrally. At least one channel is provided which extends in the drill shank and the drill head and which comprises openings on the drill head and at the clamping end. Pressurized coolant is supplied through this channel from the clamping end, which coolant exits at the drill head and in addition to cooling the drill head and the cutter it is used especially for flushing out any chips produced during the drilling through a chip removal groove which is substantially V-shaped and is provided in the drill head and in the drill shank.

Further conventional configurations of deep hole drills comprise tools with two or more cutters, which respectively extend from the central axis of the drill up to the circumference of the drill. The general configuration is similar to the tools with a cutter. In these tools, every cutter is associated with a channel for supplying coolant, which channel extends from the clamping end up to the tip of the drill and comprises respective openings at each end and also a groove for removing the produced chips, which groove extends from the tip of the drill in the direction towards the clamping end. The cross section of the chip removal grooves can be substantially U-shaped or V-shaped and can generally also have other cross-sectional contours. Guide elements can also be provided on the drill head in the case of multi-cutter tools.

Further non-embodiments of deep hole drills, preferably with at least two cutters, comprise both channels for the supply of coolant and also grooves for removing the chips, which grooves are arranged in a helical manner. These tools are generally known as twist drills or deep hole twist drills.

Deep hole drills are preferably used for introducing boreholes into workpieces which cannot be produced or not be produced economically with other production methods. These workpieces are often produced in large series. Improvements which lead to an increase in the production speed are therefore generally desirable and even small improvements lead to significant savings in the production costs.

The production speed is defined in drilling tools by the product of feed per rotation of the tool and the number of rotations per minute and is generally known as the rate of feed.

A limit for the increase in the production speed is often provided in deep hole drills in such a way that the chips can no longer be removed through the chip removal groove and clogging of the chips occurs. As already explained, the chips are removed by means of the supplied coolant. In twist drills there is an additional conveying effect by the spiral chip removal groove. Clogging of the chips especially occurs in tenacious materials when the production speed is increased, since the chips will no longer break at higher production speeds but will become increasingly longer. As a result, the chips can get stuck in the chip removal groove and can no longer be conveyed off, which may lead to the breakage of the tool and simultaneously to damage to the workpiece.

Efforts have therefore been undertaken to divide the chips in their width. Chip dividers have been used for this purpose, as shown in the embodiments below as known from the state of the art.

The cutter of a drill as described in JP 59 196108 A1 (Nippon Yaki, chip divider groove) comprises a groove according to one embodiment which is to act as a chip divider. In another embodiment a step has been provided in the straight cutter which comprises an undercut with a predetermined angle.

The drill described in the utility model DE-G 74 41 010 (Bilz, drill with chip divider) comprises two cutters. Rectangular recesses are provided in both cutters which are to act as chip dividers. As a result of the rectangular recesses, these chip dividers respectively comprise an undercut with respect to the drilling direction.

In these known chip dividers, the width of the chips is reduced by a division of the chips. Especially in the case of materials of high tenacity and at high feed rate the divided chips have a far from inconsiderable length, leading to the disadvantages as described above, which is a clogging of the chips in the chip removal groove with all the disadvantages as described above.

The invention is therefore based on the object of providing a deep hole drill which enables a high feed rate with simultaneously unproblematic removal of the chips through the chip removal grooves.

This object is achieved by the features as stated in the independent claim 1.

### SUMMARY OF THE INVENTION

It is the principal idea of the invention to provide a chip divider associated with at least one cutter in a deep hole drill and to arrange the parts of the at least one cutter which are produced by the chip divider in such a way that the chips are guided in their flow towards one another. As a result of the collision of the chips produced during cutting, tensions are introduced into the chips, leading to a fracturing of the chips. This leads to a reduction in the size both with respect to width and also with respect to the length of the chips in an exceptionally advantageous manner. By dividing the cutter with a chip divider in combination with the advantageous arrangement of the sub-cutters, very small and narrow chips are produced in the machining of the workpiece which can be removed in an especially optimal manner in the chip removal groove.

The deep hole drill in accordance with the invention especially allows a considerably higher feed rate in comparison with known deep hole drills, which feed rate allows a respectively higher production speed in industrial production. More than three times the feed rate can be achieved as compared with known deep hole drills.

The improvements are achieved by the advantageous shaping of the chips produced during the drilling. The chip divider(s) ensure(s) a division of the chip in the longitudinal direction, so that the chip width is limited. As a result of the arrangement of the sub-cutters and the resulting collision of the chips, fracturing of the chips is achieved and therefore a limitation in the length of the chips. Removal of the chips is also ensured in this manner with a reduced supply of coolant. A high level of process stability is thereby achieved with the deep hole drill in accordance with the invention. In particular, a breakage of the drill which would lead to the destruction of the workpiece to be drilled can reliably be prevented by avoiding any clogging of the chip removal groove.

The deep hole drill in accordance with the invention therefore generally offers considerable advantages in use, especially in industrial series production.

Further embodiments and further developments of the deep hole drill in accordance with the invention are the subject matter of the dependent claims.

An especially advantageous embodiment provides that the at least one chip divider is realized as a groove. Alternatively, the at least one chip divider can be realized as a step.

One advantageous embodiment provides that the number of the chip dividers is fixed depending on the diameter of the deep hole drill, wherein several chip dividers can be provided with increasing diameter of the drill.

One further embodiment provides that the chip divider has a free-punch angle of larger 0° relating to a parallel line to the central axis of the drill. The undercut of the chip divider produced thereby forms a cutting corner in a way and increases the reliability of chip division. A further development of this embodiment provides that the free-punch angle is fixed depending on the material of the workpiece to be drilled. The free-punch angle preferably lies in a range of 1° to 60°, especially in the range of 8° to 12°.

The chip divider(s) are arranged in/on at least one cutter of the deep hole drill. They are arranged in/on the cutters in such a way that they subdivide them substantially into the equally long sections in order to thereby subdivide the chip into several substantially equally wide sections. The division especially occurs in such a way that the cutting edge is divided in such a way that the longest sub-cutter is at most twice as long as the shortest sub-cutter.

The sub-cutters are arranged in such a way that the chips obtained during machining are guided towards one another and will collide by utilizing their direction of flow resulting from their cutting from the surface of the workpiece. As a result of the collision, tensions are introduced into the chips which lead to a breakage and therefore to a separation of the chips, by means of which the chips are limited in their length.

It is assumed in a simplifying manner when regarding the direction of flow of the chips that the direction of flow of a chip of a sub-cutter is perpendicularly to the connecting line of the two outermost ends of the sub-cutter or the chord through the respectively innermost and outermost cutting end of each sub-cutter and is directed away from the workpiece in the direction towards the chip removal groove. This direction will be referred to below as cutter normal and is relevant for the arrangement of the sub-cutters with respect to each other.

Those parts of a cutter are defined as sub-cutters which are arranged between the central axis of the deep hole drill and a chip divider, between two chip dividers or between the chip divider and the circumference of the drill head.

In accordance with an advantageous embodiment, the sub-cutters can be arranged in such a way that the cutter normals of the sub-cutters are disposed at an angle of 20° to 90° to each other. The arrangement in the range of an angle of 30° to 70° leads to an especially advantageous influence on the chips, leading to chip breakage.

The sub-cutters can be provided with a substantially straight configuration, but they can also have different straight or curved sections. One advantageous embodiment provides that at least the sub-cutter adjacent to the circumference of the drill head has a contour which is curved to the outside.

It can be provided in tools with only one cutter that the sub-cutter which is directly adjacent to the circumference of the drill head has an outwardly curved contour, especially the arc of a circle and a cutting corner on the transition to the circumference.

The arrangement of the chip divider and the arrangement of the sub-cutters with respect to each other depend on the material to be processed and its deformation capabilities, the process parameters, the used cooling lubricant and other factors.

It can be provided according to an advantageous embodiment that the deep hole drill is composed of a drill head and the drill shank, or that the drill head and the drill shank are made integrally. Alternatively, an exchangeable drill head can be provided.

Further embodiments relate to the drill head which can be made of hard metal for example and/or can be provided with a coating such as a hard-material coating. The service life of the deep hole drill can be extended considerably by these measures.

Further advantageous further developments and embodiments of the deep hole drill in accordance with the invention are the subject matter of the description below.

Embodiments of the invention are shown in the drawing and will be explained in closer detail in the description below, wherein:

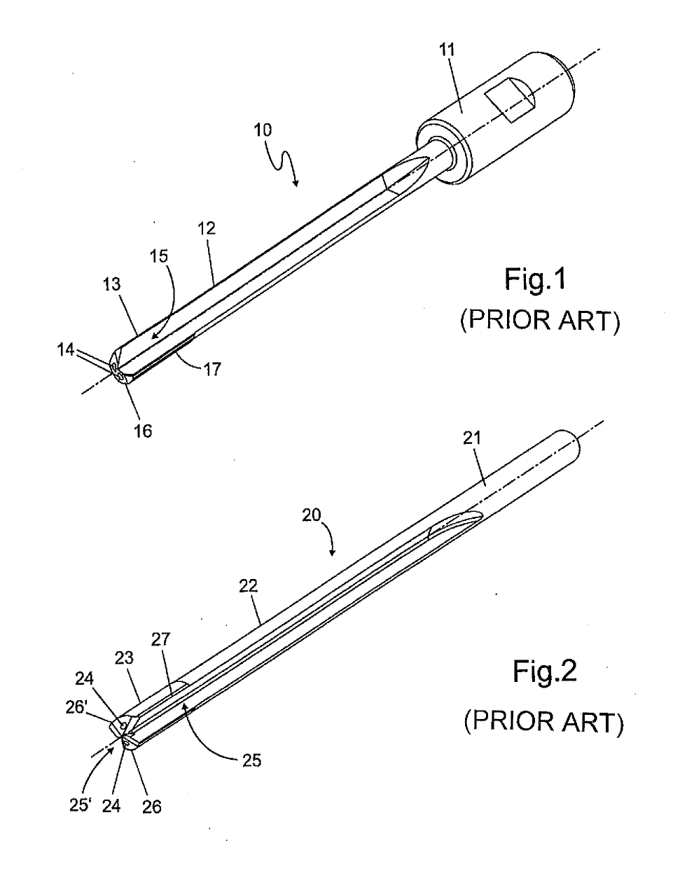

FIG. 1 shows a deep hole drill according to the state of the art with a cutter without chip divider, which is usually referred to as single-lip drill;

FIG. 2 shows a deep hole drill according to the state of the art with two cutters without chip divider and in a straight grooved configuration, which is usually referred to as a double-lip drill;

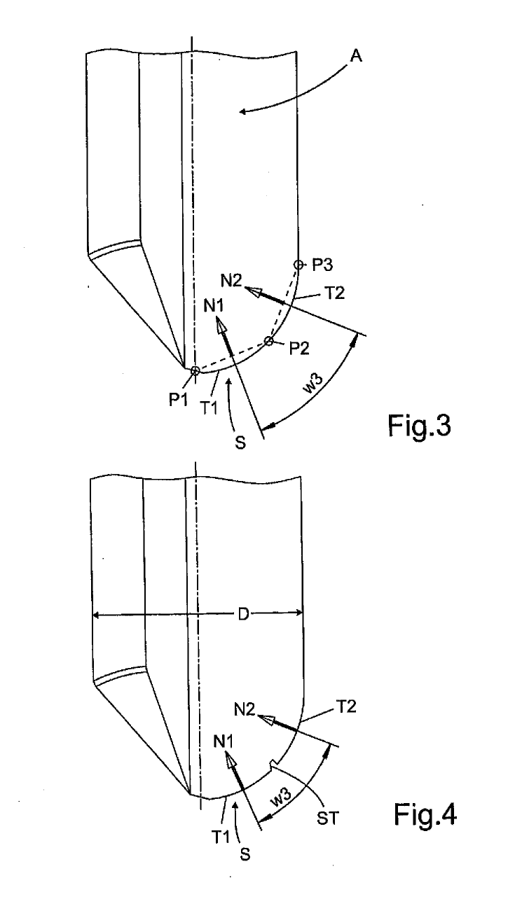

FIG. 3 shows a principal illustration of the division of the cutter into sub-cutters of a deep hole drill in accordance with the invention;

FIG. 4 shows a first embodiment of a deep hole drill in accordance with the invention with a curved cutter and a chip divider arranged as a groove;

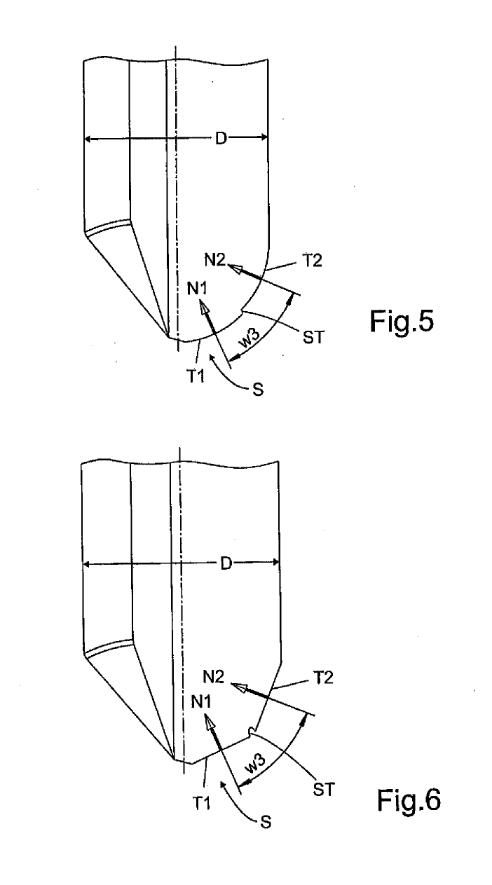

FIG. 5 shows a further embodiment of a deep hole drill in accordance with the invention with a curved cutter and a chip divider arranged as a step;

FIG. 6 shows a further embodiment of a deep hole drill in accordance with the invention with a cutter and with substantially straight sub-cutters and a chip divider arranged as a groove;

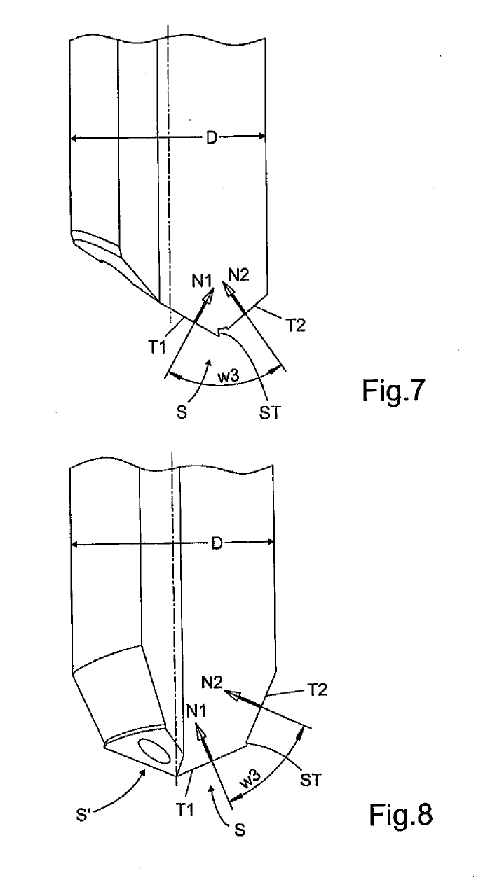

FIG. 7 shows a further embodiment of a deep hole drill in accordance with the invention with a cutter and with substantially straight sub-cutters and a chip divider arranged as a groove;

FIG. 8 shows a further embodiment of a deep hole drill in accordance with the invention with two cutters with substantially straight sub-cutters and chip dividers arranged as steps;

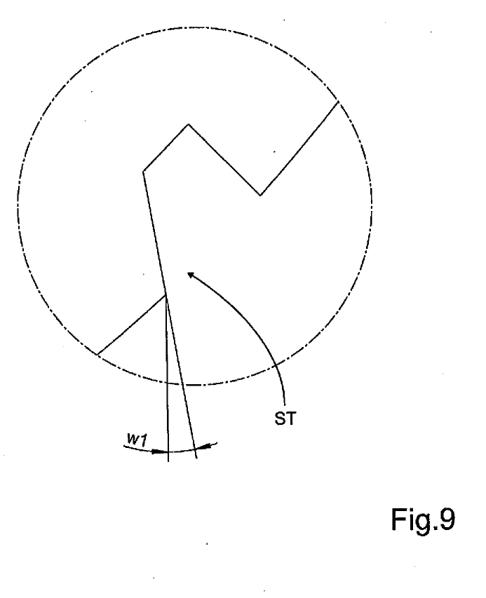

FIG. 9 shows an enlarged view of the chip divider arranged as a groove, with illustration of the free-punch angle w1.

### DESCRIPTION OF THE PREFERRED EMBODIMENTS

FIG. 1 shows a deep hole drill 10 with a cutter 16, as known from the state of the art. The deep hole drill 10 contains a clamping end 11 for accommodating the deep hole drill 10 in a drill chuck which is not shown in closer detail in FIG. 1 and a drill shank 12 with a drill head 13. The drill shank 12 and the drill head 13 are realized in an integral way. At least one coolant channel 14 is provided in the drill shank 12, which coolant channel opens into the front end of the drill head 13. The coolant pumped through the coolant channel 14 is not only provided for cooling the drill head 13, but is also used for removing the chips produced during drilling through a V-shaped chip removal groove 15, which commences on the cutter 16 of the deep hole drill 10 and extends virtually over the entire length of the drill shank 12. At least one guide element 17 can be provided on the circumference of the drill head 13.

FIG. 2 shows a deep hole drill 20 with two cutters 26, 26′, as known from the state of the art. The deep hole drill contains a clamping end 21 for accommodating the deep hole drill 20 in a drill chuck which is not shown in closer detail in FIG. 2 and a drill shank 22 with a drill head 23. The drill shank 22 and the drill head 23 are realized in an integral way. At least two coolant channels 24 are provided in the drill shank 22, which coolant channels open into the front end of the drill head 23. The coolant pumped through the coolant channels 24 is not only provided for cooling the drill head 23, but is also used for removing the chips produced during drilling through the V-shaped chip removal grooves 25, 25′ which respectively originate on a cutter 26, 26′ of the deep hole drill 10 and extend virtually over the entire length of the drill shank. At least one guide element 27 can be provided on the circumference of the drill head 23.

In FIG. 3, the cutter area of a deep hole drill making use of the invention is shown with a cutter S, which extends from the point P1 on the central axis up to a point P3 on the diameter (circumference) of the deep hole drill and which is subdivided at a point P2 by a chip divider (not shown) into two sub-cutters. One sub-cutter T1 extends from point P1 to the point P2, another sub-cutter T2 extends from the point P2 up to the point P3. The cutter normal N1 of the sub-cutter T1 extends perpendicularly to the connecting line P1-P2, the cutter normal N2 of the sub-cutter T2 extends perpendicularly to the connecting line P2-P3. The cutter normals are respectively directed away from the workpiece in the direction of the chip removal groove A and enclose an angle w3 with each other.

FIGS. 4 to 6 show further embodiments of the deep hole drill in accordance with the invention, with the same elements here being provided with the same reference numerals as in FIG. 3. In the deep hole drill as shown in FIG. 4, a curved cutter S is provided with a chip divider ST arranged therein, which is arranged as a groove.

All illustrated deep hole drills have a diameter D which corresponds to the drilling diameter.

In the deep hole drill as shown in FIG. 5, a curved cutter S with a chip divider ST arranged as a step is provided.

The deep hole drill as shown in FIG. 6 comprises a cutter S with substantially straight sub-cutters T1 and T2, between which a chip divider ST configured as a groove is arranged.

The deep hole drill as shown in FIG. 7 comprises a cutter S with substantially straight sub-cutters T1 and T2 and a chip divider ST which is arranged as a groove. The cutter normal N1 faces away from the central axis and the cutter normal N2 faces towards the central axis. An especially simple production of the deep hole drill can be achieved with this arrangement of the sub-cutters T1, T2, because the general arrangement of the sub-cutters T1, T2 corresponds to a known standard polished section. An especially advantageous breakage of the chips is achieved by the large angle w3 of the cutter normals N1, N2 with respect to each other.

The deep hole drill as shown in FIG. 8 comprises two cutters S, S′ with substantially straight sub-cutters T1, T2 and a chip divider ST arranged as a step. The two cutters T1, T2 are arranged symmetrically with respect to the central axis.

FIG. 9 shows an enlarged illustration of the chip divider ST of a deep hole drill which is arranged as a groove, A free-cutting angle w1 which is larger than 0° ensures a secure division of the chip even in the case of highly tenacious materials.

1: A deep hole drill, comprising at least one cutter (S) which is arranged on a drill head and which comprises at least one cutting edge, with the at least one cutter (S) being subdivided into at least two sub-cutters (T1, T2) by at least one chip divider (S) for dividing the chips removed by the cutting edge, wherein the sub-cutters (T1, T2) of at least one cutter (S) are arranged relative to each other in such a way that the cutter normals (N1, N2) of at least two sub-cutters (T1, T2) are aligned at an angle (w3) of at least 20° to each other.

2. A deep hole drill according to claim 1, wherein the deep hole drill comprises a cutter (S) and at least the sub-cutter (T2) which is directly adjacent to the circumference of the deep hole drill has an outwardly curved contour.

3. A deep hole drill according to claim 2, wherein the sub-cutter (T2) which is directly adjacent to the circumference of the deep hole drill comprises a cutting corner at the transition to the circumference of the drill head.

4. A deep hole drill according to claim 1, wherein the at least one chip divider (ST) is realized as a groove.

5. A deep hole drill according to claim 1, wherein the at least one chip divider (ST) is realized as a step.

6. A deep hole drill according to claim 1, wherein the number of the chip dividers (ST) is determined depending on the drilling diameter (D).

7. A deep hole drill according to claim 1, wherein the chip divider(s) (ST) subdivide(s) the cutting edge into approximately equally long areas.

8. A deep hole drill according to claim 1, wherein the chip divider(s) (ST) subdivide(s) the cutting edge in such a way that the longest sub-cutter is maximally twice as long as the shortest sub-cutter.

9. A deep hole drill according to claim 1, wherein the cutter normals (N1, N2) of at least two sub-cutters (T1, T2) are aligned at an angle (w3) of 30° to 70° to each other.

10. A deep hole drill according to claim 1, wherein the chip divider (ST) has a chip-divider free-punch angle (w1) of larger than 0° with respect to the central axis of the drill.

11. A deep hole drill according to claim 1, wherein the deep hole drill comprises a drill head and a drill shank, and wherein the drill head and the drill shank are produced in an integral way.

12. A deep hole drill according to claim 1, wherein the deep hole drill is composed of a drill head and a drill shank.

13. A deep hole drill according to claim 12, wherein the drill head is exchangeable

14. A deep hole drill according to claim 1, wherein the at least one drill head is made from a wear-proof material, especially hard metal.

15. A deep hole drill according to claim 1, wherein at least the drill head is provided at least partly with a coating.
